(19) United States
(12) Patent Application Publication
(10) Pub. No.: US 2015/0099076 A1
(43) Pub. Date: Apr. 9, 2015

(54) PROCESS FOR MANUFACTURING A COMPOSITE MATERIAL

(71) Applicants: Dimitri Liquet, Angleur (BE); Carlos Alberto Paez, Liege (BE); Cedric Calberg, Esneux (BE); David Eskenazi, Liege (BE); Jean-Paul Pirard, Chenee (BE); Benoit Heinrichs, Liege (BE)

(72) Inventors: Dimitri Liquet, Angleur (BE); Carlos Alberto Paez, Liege (BE); Cedric Calberg, Esneux (BE); David Eskenazi, Liege (BE); Jean-Paul Pirard, Chenee (BE); Benoit Heinrichs, Liege (BE)

(73) Assignee: PRAYON SA, Engis (BE)

(21) Appl. No.: 14/401,100

(22) PCT Filed: May 16, 2013
(86) PCT No.: PCT/EP2013/060129

§ 371 Date: Nov. 13, 2014

(30) Foreign Application Priority Data
May 16, 2012 (BE) 2012/0326

(51) Int. Cl. C23C 22/05; C23C 22/78; C23C 22/82; C09D 5/03

(52) U.S. Cl. CPC C23C 22/05; C09D 5/03; C23C 22/78; C23C 22/82
USPC 428/34.6; 423/605; 423/594.6; 427/301; 428/469; 428/432; 428/702; 428/446; 428/471; 428/472; 428/472.2; 428/392

(57) ABSTRACT

A process for manufacturing a composite material comprising a functionalization of the substrate, which comprises treatment of said substrate with at least one first alcoholic solvent, functionalization of a first powder and formation of a first colloidal sol of said functionalized first powder in a second solvent, at least one application of a layer of said first colloidal sol of said first powder to the substrate, drying of said layer of said first colloidal sol and formation of a layer of first coating formed by said first colloidal sol, adherent to said substrate, by heating at a temperature above 50° C. and below 500° C.

The present invention relates to a method for manufacturing a composite material comprising a substrate and a coating based on powder.

Such a method is known for example from document WO2012005977 which describes a method for coating substrates, the surface of which, which is imperfect and which may be flexible, has to be coated with a layer of yttrium oxide. According to the teaching of this document, a solution of an yttrium oxide precursor in a solvent is applied by coating the substrate with a layer of the solution. Next, the substrate is heated in order to remove the solvent and the oxide precursor is converted into yttrium oxide. This succession of steps may be repeated.

Unfortunately, such a method requires a great amount of energy for carrying out the conversion of the yttrium oxide precursor into yttrium oxide, which is not consistent with increasingly strict environmental regulations presently. Further, the obtained coating is provided for filling rough portions but does not seem to be suitable for covering a substrate homogenously. Within the scope of the present invention, by the term of <<calcinations>> is meant a step consisting of heating a mineral sample to a high temperature (typically beyond 500° C. and up to about 1,200° C.) in air or in a neutral atmosphere. As opposed to this, by the term of <<combustion>> is meant a step consisting of heating an organic sample in the presence of an oxidizer, for example air or pure oxygen, in order to produce typically water and CO₂, this step typically occurring at temperatures below 550° C.

Other methods are also known in the state of the art, like electrodeposition of ceramic materials by electrolysis (ELD) or by electrophoresis (EPD). Electrodeposition is achieved by the movement of charged particles under application of an electric field. These charged particles are initially in solution and are deposited on an electrode. The deposition of the particles by electrolysis produces colloidal particles in cathodic reactions so that they are subsequently deposited.

Unfortunately, this type of method requires sometimes quite consequent facilities when the question is to apply these colloidal particles over large surface areas and requires a relatively significant amount of energy in order to extract the colloidal particles and then have them migrate or for simply having them migrate according to whether they are presently in an ELD or EPD method.

Within the scope of the deposition of particles by electrolysis, forces between the particles exist which may cause a lot of drawbacks such as the coagulation of the colloidal suspension, the generally required presence of additives, . . . .

Therefore this results in certain cases in non-homogeneity of the coating and in the presence of undesired contaminating molecules.

Recently, Zhitomirsky et al. (J. Colloid. Interface Science 352 (2010—pages 371 to 378)) studied the deposition of particles by electrolysis in order to make TiO₂ and MnO₂ films. Certain additives of the colloidal suspension based on benzoic acid and comprising phenolic molecules were tested, such as 4-hydroxybenzoic acid, 3,5-dihydroxybenzoic acid, gallic acid, salicylic acid and its sodium salts. The deposition yields were studied according to the concentration of additives and to the deposition time for deposits at the cathode of suspensions containing benzoic acid, 4-hydroxybenzoic acid and 3,5-dihydroxybenzoic acid and for deposits at the anode of suspensions containing gallic acid or sodium salts of salicylic acid.

The results obtained for phenolic molecules comprising a variable number of OH groups were analyzed relatively to the results obtained with benzoic acid not comprising any OH group. The OH groups, but also the OH groups adjacent to COOH groups bound to the aromatic rings of the phenolic molecules are beneficial for adsorption of the molecules on the oxide particles. The adsorption mechanisms seem to involve interaction of the COOH and OH groups of the organic molecules with the metal ions at the surface of the particles. Gallic acid is an efficient filler additive which provides stabilization of TiO₂ and MnO₂ particles in suspensions and allows their deposition. Composite films containing TiO₂—MnO₂ may be obtained with gallic acid as a common dispersant agent for TiO₂ and MnO₂. The Ti/Mn ratio in the composite film may range up to 1.3. The thickness of the films may range up to 10 μm. The oxide suspension which is displaced therein further results in a coating, the adhesion properties of which are not disclosed. Reproduction of the teaching of this document further leads to the deposition of a film which is easily removed and which is therefore non-adherent.

Unfortunately, these techniques involve great consumption of energy and are generally costly to apply.

Further, deposits of powder particles by PVD (physical vapor deposition) on steel metal sheets or on silicon discs covered with platinum are known. Unfortunately, these methods also involve significant energy expenditures in order to guarantee favorable conditions to the deposition of the layer (high vacuum) and involve slowness of deposition which is difficult to adapt to industrial production. Further, the cost of such a facility is prohibitive.

Depositions via a sol-gel route on glass objects (optical glass or glass used in the building industry) are today an alternative to the aforementioned deposition methods and processes, but for most of the time, introduce the presence of materials or elements which are not always specifically desired in the deposited layers.

Composite products therefore comprising a substrate and a coating from these methods via a sol-gel route are the subject of increasing interest of the market in the fields of optics, electronics, of the building industry, in order to impart particular functions to surfaces which are initially without them, but also in fields as varied as domestic electric appliances, self-cleaning materials in the building industry and more specifically materials intended for the green energy market with photovoltaic surfaces or surfaces of solar concentrators, materials intended for energy storage devices such as lithium ion batteries, supercapacitors or further catalytic materials.

The interest of the market described above also lies in the capability of being able to deposit coating layers of oxide mixtures or composite layers.

The present invention therefore more particularly relates to a method for manufacturing a composite material comprising a substrate and a coating based on powder comprising:
a) functionalization of the substrate comprising a treatment of a surface of said substrate with a first solution containing at least one first alcohol solvent,
b) formation of a first stable colloidal sol,
c) at least one application of at least one layer of said first colloidal sol onto the functionalized substrate,
d) drying of said at least one layer of said first colloidal sol and
e) formation of a layer of a first coating formed by said first colloidal sol, adhering to said substrate, by heating to a temperature above 50° C. and below 500° C.

A method of this type is known from the article of E. Gressel-Michel et al. entitled <<From a microwave flash-synthesized TiO₂ colloidal suspension to TiO₂ thin films>> which teaches a method for preparing a colloidal sol of TiO₂ which was synthesized by the MWAR (Microwave Autoclave Reactor) method consisting of exposing an aqueous solution containing TiCl₄ and HCl to microwaves. Thin layers, based on the colloidal sol of TiO₂ are then applied by immersion (dip coating) onto a substrate, for example a soda-lime glass functionalized beforehand in ethanol.

Unfortunately, this type of method does not allow perfect control of the characteristics of the oxide since the latter is generated in situ from precursors (TiCl₄ and HCl). Further, this document discloses (point 3.5 of the document) that the thin layer was not able to be characterized by XRD which leads to the conclusion of the reader that the thin layer based on TiO₂ is not crystallized and is not pure anatase. Finally, the method involves the use of a microwave autoclave reactor (MWAR) which makes the method restrictive from an economical and practical point of view.

As this may be seen from the foregoing, present known methods, in particular those described hereinbefore, suffer from major drawbacks lying in the energy demand, in the nature of the substances used or in the fact that the oxides are formed in situ from precursors, which, on the one hand, does not allow perfect control of their characteristics.

On the other hand, the composite products obtained should advantageously have coating properties identical or almost identical with those of powders, in particular of oxides which are incorporated therein, like hydrophilicity, electric conduction, catalytic activity, antistatic properties, ionic conduction, controlled porosity and controlled permeability, either in combination or not. The coated powders on the substrates should therefore be degraded or transformed as less as possible during the deposition method on the substrate. Further, the adhesion of the coating on the substrate should be high and the particles of applied powders for forming the coating should be uniformly dispersed over the surface of the substrate. This is sometimes difficult to obtain, given that often the powdery materials to be deposited as a coating layer only actually have reduced affinity for the substrate onto which the layer has to be deposited and segregation of the materials at a nanometric scale is often difficult to avoid during depositions.

The object of the invention is to find a remedy to the drawbacks of the state of the art by providing a method allowing deposition of powders, in particular of oxides, in a not very costly way in energy, and this with optimum adhesion properties of the coating and homogenous distribution of the particles in the coating, thereby imparting homogeneity of the properties to the substrate through the coating, and this in a way such that the coating of the powder to be applied retains the nature and the properties of the powder when it forms the coating.

In order to solve this problem, a method is provided according to the invention, as indicated in the beginning, further comprising:

f) before forming said first stable colloidal sol, functionalization of a first powder and in that said first stable colloidal sol is based on said first powder, functionalized in a second solvent, said coating being formed with said first uniformly distributed powder.

As this may be seen from the foregoing, the powder to be applied for forming the coating in the sense of the present invention is functionalized and forms a colloidal sol which contains the functionalized powder in a solvent. The goal is to immobilize on the substrate, properties/functions identical with those which are present in the powder and absent on the substrate.

A colloid or a colloidal sol, in the sense of the present invention is a substance in the form of a liquid or a gel which contains as a colloidal suspension, sufficiently small particles, so that the mixture is homogenous. The colloidal sol in the sense of the present invention forms a homogeneous dispersion of solid particles having a particle size generally from 2 to 1,000 nanometers, preferably from 2 to 500 nanometers, more preferentially from 2 to 200 nanometers.

In order to obtain a colloidal sol with which it is possible to ensure regular and homogenous coating of the substrate, a stable colloidal sol should be obtained. The stability of a colloidal solution results from the balance between the attracting interactions and the repelling interactions which are exerted on and between the particles and according to the present invention, by the specific use of a solvent, for example an alcohol, optionally in the presence of an agent bearing a carboxyl or carboxylate function. According to the invention, it was possible to obtain a stable colloidal sol for a period of at least 24 hours, preferably for at least 3 days, or even for several weeks or months, with which homogeneous coating may be obtained, in which the particles of powders are perfectly dispersed. The notion of stability period will depend on the oxides used. For example, MnO₂ exhibited a stability of five months in the colloidal sol according to present invention while LiCoO₂ exhibits stability for at least one day to 14 days. The preparation of the colloidal sols according to the present invention therefore allows a homogenous sol to be obtained, without segregation of nanometric particles, which allows homogenous layers to be made of the selected powdery product. The formulation of the sol is therefore adapted so as to guarantee good homogeneity, a capability of being able to use it subsequently with diverse deposition methods.

Indeed, the stability of the colloidal sol according to the present invention inter alia allows the use of many application techniques such as an automatic applicator of films such as for example a bar coating applicator (bar coater), such as an Elcometer 4340, optionally equipped with a spiral bar with a predetermined depth, such as for example from 2 to 6 μm, a coating applicator by immersion (dip coater), a centrifugal coater (spin coater), a coater with spraying (spray coater), a coater with sliding (slide coater), a printer for screen printing (screen printer), and a slot coater (slide coater), an ink jet printer or further a coater with rolls (roll coater). In this way, the colloidal sol because of its homogeneity and its stability may be applied in different ways and therefore on many different substrates such as substrates with a planar shape or not, threads, fibers, flexible substrates or further substrates which still have to be shaped since the adherence remains guaranteed. This method according to the present invention therefore allows multiple functions to be contemplated, the use of multiple substrates and powders. The resulting film from the application of one or several layers of powder from the repeated application of a colloidal sol layer according to the present invention is then carefully dried at a low temperature and does not involve any electrochemistry.

The method according to the present invention is therefore capable of depositing layers of coatings from powders, in particular from oxides, without resorting to demanding methods in terms of energy and guaranteeing the purity of the deposit made according to that of the product in the form of a powder, since it does not resort to binders which may again be found in the coating from the moment that these binders, within the scope of the present invention are removed in the combustion step by heating to a temperature from 50 to 500° C., in step e). The powders, in particular of oxides provided with particular properties (for example catalytic, photo-catalytic, conducting, coloring properties) therefore impart to the substrate via the formed adherent coating, the same particular properties and this in a uniform way over the whole surface of the coated substrate. As the adherence is an essential characteristic to the quality of the coating, the substrate is according to the invention functionalized beforehand with OH groups stemming from the treatment with the first alcohol solvent. Said powder to be deposited is also functionalized and forms a colloidal sol of said functionalized powder in said second solvent.

Further, in the method according to the invention, the coating adhering to said substrate, is obtained after treatment by heating to a temperature above 50° C. and below 500° C. which allows evaporation and/or combustion of said alcohol solvents and of the agent(s) bearing a carboxylic or carboxylate function, in particular of the carboxylic acid(s) used for forming the colloidal sols and functionalizing the surfaces and powders. In this way, the purity of the coating is guaranteed, the substrate is coated with an adherent coating formed of pure powder upon leaving the method, and this all the more so since no binder is again found in the coating. As this is seen, the heat treatment is a combustion, i.e., a gentle treatment, not requiring the use of so-called calcination temperatures and therefore having limited environmental impact since it is not necessary to provide the deposit with energy in an exaggerated way in order to obtain properties related to the temperature (for example crystallinity or the photoactivity induced by the latter).

Finally, the fact must further be stressed that the succession of the steps of the method according to the present invention has kinetics compatible with industrial running lines, which makes it easily adaptable without necessarily requiring any additional equipment relatively to the existing coating lines.

Advantageously, said step c) and d) are alternatively repeated a predetermined number of times corresponding to the number of required layers of said first powder in order to form said first coating.

In this way, it is possible according to the present invention to obtain a coating formed with several layers of colloidal sol. The formation of the coating formed with said colloidal sol, adhering to said substrate, by heating to a temperature above 50° C. and below 500° C. is only required after a predetermined number of successive steps c) and d), for example 10 times. It is therefore possible to obtain the desired thickness of the coating by repeating 10 times steps c) and d), by applying step e) and by beginning again with 10 applications of steps c) and d) successively before opting for a second step e), and this until the desired thickness is obtained.

In another embodiment according to the present invention, the method further comprises the steps of
a) functionalization of an nth powder (n≧2) and formation of an nth (n≧2) colloidal sol containing said nth (n≧2) functionalized powder in a Zth (Z≧n+1) solvent,
b) application of at least one layer of said nth colloidal sol of said nth powder on the substrate coated with said (n−1)th coating,
c) drying of said at least one layer of said nth colloidal sol and
d) optionally formation of a coating layer formed with said nth colloidal sol of said nth powder, adhering to said (n−1)th coating, by heating to a temperature above 50° C. and below 500° C.

As this may be seen, the method according to the present invention also allows formation of a substrate provided with a first coating from a first powder (which may itself optionally be a mixture of several powders) and subsequent formation on this first coating, a second coating and so forth until the desired succession of coatings is obtained. The obtained coated substrate according to the present invention may therefore include a substrate coated with a coating A, a coating B, a coating C and with a coating D but also with a coating A, a coating B, a coating A and still finally a coating B (any other combination being moreover possible).

Advantageously, said steps b) and c) are repeated in alternation with a predetermined number of times corresponding to the number of layers of said nth powder in order to form said nth coating.

In this way, it is possible according to the present invention to obtain a coating formed with several layers of the nth colloidal sol. The formation of the coating formed with said colloidal sol, adhering to said substrate, by heating to a temperature above 50° C. and below 500° C. is only required after a predetermined number of successions of steps b) and c), for example 10 times. It is therefore possible to obtain the desired thickness of the coating by repeating 10 times steps b) and c), by applying step d) and by beginning again with 10 applications of steps b) and c) successively before opting for a second step d), and this until the desired thickness is obtained. In one alternative, it is possible to apply several times steps b) and c) with the first powder and several times steps b) and c) with the nth powder and then only forming a coating formed with said colloidal sol, adhering to said substrate, by heating to a temperature above 50° C. and below 500° C.

In certain cases, said first and/or said nth colloidal sol contains water.

Preferably, said powder is a powder comprising an alkaline metal oxide, an earth-alkaline metal oxide, a transition metal oxide, a low metal oxide, a metalloid oxide, a lanthanide oxide, an actinide oxide, preferably a metal oxide and/or a silicon oxide, more preferentially comprising one or more oxides selected from the group of lithium, sodium, cerium, titanium, vanadium, chromium, molybdenum, manganese, iron, cobalt, nickel, palladium, copper, zinc, cadmium, aluminum, silicon, tin and lead oxides and combinations thereof, such as mixed oxides of cobalt and lithium, iron and manganese, lithium and titanium, and the like.

In an advantageous embodiment of the present invention, said substrate is selected from the group consisting of metal, of glass or quartz, of a ceramic support, or of any other material coated with titanium dioxide or silicon oxide, preferably a metal, a ceramic support or any other material coated with titanium dioxide or silicon oxide from the moment that these substrates are particularly difficult to coat with oxides, especially when it is desirable that the oxide be uniformly distributed and retain its initial properties.

Preferably, said metal is selected from the group consisting of steel, in particular low, medium or high carbon steel, rolled, either coated or not, either shaped or not, flat or shaped stainless steel, platinum, optionally deposited on another support, aluminum, either rolled or not, optionally shaped, more particularly, said metal is selected from the group of sheet-coated steel, pre-painted steel, sheet aluminum or steel coated with a layer of titanium dioxide.

Advantageously, said glass or quartz is selected from the group consisting of glass containing alkaline metals or not, either flat or shaped such as with the shape of a tube, threads or fibers, quartz in the shape of a sheet, tube, threads or further fibers and the like.

Advantageously, said first and/or said nth colloidal sol is formed in the presence of an agent bearing a carboxyl or carboxylate function.

More particularly, said functionalization step (steps a) and b)) of said first powder with formation of said first colloidal sol containing said first functionalized powder comprise the following steps:
a) preparing a first solution S1 of said agent bearing a carboxyl or carboxylate function in said second solvent SO1, which is selected from organic alcohol with a linear, saturated or unsaturated chain, comprising at least one alcohol function.
b) preparing a suspension Sp1 by dispersion of said first powder in said first solution S1,
c) adding water to said first solution S1 in order to form a dilute solution S1d,
d) mixing said dilute solution S1d and said suspension Sp1 at a temperature comprised between 10° C. and the reflux temperature of said second solvent and
e) homogenizing said mixture, until said first colloidal sol containing said first functionalized powder is obtained.

Advantageously, the homogenization may optionally be improved with ultrasound. Said powder to be deposited is therefore functionalized via said second alcohol solvent and on the other hand via said agent bearing a carboxyl or carboxylate function while allowing the formation of a stable colloidal sol SOL1.

Further, in a particular embodiment, said functionalization step (steps a and b) of said nth powder (n≧2) with formation of an nth (n≧2) colloidal sol containing said nth functionalized powder (n≧2), comprise the following steps:
a) preparing an nth (n≧2) solution Sn of said agent bearing a carboxyl or carboxylate function in said Zth (Z≧n+1) solvent SO₂, which is selected from saturated or unsaturated organic alcohols with a linear chain, comprising at least one alcohol function,
b) preparing a suspension Spn by dispersing said nth (n≧2) powder in said nth (n≧2) solution Sn,
c) adding water to said nth (n≧2) solution Sn in order to form an nth (n≧2) dilute solution Snd,
d) mixing said nth (n≧2) dilute solution Snd and said suspension Spn at a temperature comprised between 10° C. and the reflux temperature of said Zth (Z≧n+1) alcohol solvent and
e) homogenizing said mixture until said nth (n≧2) colloidal sol containing said nth (n≧2) functionalized powder is obtained.

The homogenization may optionally be improved with ultrasound. Also in this case, said powder to be deposited is functionalized via said Zth alcohol solvent and on the other hand for providing said agent bearing a carboxyl or carboxylate function, a carboxylic group which additionally has formation of a stable colloidal SOLn.

Advantageously, in an alternative according to the invention, said first powder is functionalized in a functionalization solvent Sf, optionally in the presence of water in order to achieve preliminary functionalization of the powder to be deposited before forming the colloidal sol with the following steps:
a) preparing a suspension Sp1 by dispersing said first functionalized powder in said second solvent SO₁.
b) adding water to said second solvent SO₁ in order to form a dilute solution S₁d
c) mixing said dilute solution S₁d and said suspension Sp1 at a temperature comprised between 10° C. and the reflux temperature of said second solvent SO₁,
d) homogenizing said mixture until an intermediate colloidal sol containing said first functionalized powder is obtained and,
e) adding to said intermediate colloidal sol a solution containing an agent bearing a carboxyl or carboxylate function in a third solvent, preferably an alcoholic one in order to form said first colloidal sol SOL1.

In another alternative, said nth powder (n≧2) is functionalized in a functionalization solvent Sf, optionally in the presence of water, in order to achieve preliminary functionalization of the powder to be deposited before forming the colloidal sol with the steps:
a) preparing a suspension Spn by dispersing said nth powder (n≧2) in said Zth (Z≧n+1) solvent (SOZ),
b) adding water to said Zth solvent (Z≧n+1) in order to form a dilute solution Snd,
c) mixing said dilute solution Snd and said suspension Spn at a temperature comprised between 10° C. and the reflux temperature of said Zth solvent (Z≧n+1),
d) homogenizing said mixture until an intermediate colloidal sol of a solution containing said nth functionalized powder is obtained,
e) adding to said intermediate colloidal sol a solution containing an agent bearing a carboxyl or carboxylate function in a third solvent, preferably an alcoholic one, in order to form said nth colloidal sol SOLn.

In a particularly preferential embodiment of the present invention, said first alcohol solvent, said second solvent, said third solvent and said Zth (Z≧n+1) solvent are selected independently of each other from the group consisting of water and of saturated or unsaturated organic alcohols with a linear chain, comprising at least one alcohol function, and preferably selected from the group of methoxyethanol, ethanol, ethylene glycol, 1-propanol, methanol, n-butanol, 2-phenylethanol and 2-propanol and mixtures thereof and may be either identical or different.

In an advantageous alternative according to the invention, said first alcohol solvent comprises an additive, preferably selected from the group of ethylene glycol, polyethylene glycol 200, polyethylene glycol 400, polyethylene glycol 1500, polyethylene glycol 10000 and polyethylene glycol 15,00000, ethoxylated natural fatty acids, preferably based on stearyl alcohol, more particularly Brij® S10, Pluronic F120®, sodium dodecylbenzene sulfonate and 4-hydroxybenzoic acid as well as mixtures thereof.

According to a preferential embodiment, said functionalization solvent is selected from the group consisting of ethylene glycol, polyethylene glycol 200, polyethylene glycol 400, polyethylene glycol 1500, polyethylene glycol 10000 and polyethylene glycol 15,00000, ethoxylated natural fatty acids, preferably based on stearyl alcohol, more particularly Brij® S10, Pluronic F120®, and sodium dodecylbenzene sulfonate, para-hydroxybenzoic acid, as well as mixtures thereof.

Preferentially, said agent bearing a carboxyl or carboxylate function is a carboxylic acid or the associated carboxylate selected from the group of monofunctional or polyfunctional carboxylic acids, optionally having alcohol chains and/or optionally benzene rings and/or having saturated or unsaturated carbon chains, preferably, said agent bearing a carboxyl or carboxylate function is 4-hydroxybenzoic acid.

Advantageously, said agent bearing a carboxyl or carboxylate function is a carboxylic amino acid, in particular tyrosine.

Other embodiments of the method according to the invention are indicated in the appended claims.

The object of the invention is also a composite material, for example obtained with the method according to the present invention.

In particular, the present invention relates to a material comprising a substrate and at least one coating based on powder characterized in that said coating consists of said powder and has an adhesion to said substrate of more than 17 N/mm² according to the ASTM4541 standard.

Advantageously, the material includes according to the present invention, an nth coating (n≧2) based on an nth powder, in which said nth coating consists of said nth powder.

In the material according to the invention, preferably, said powder is a powder comprising an alkaline metal oxide, an earth-alkaline metal oxide, a transition metal oxide, a low metal oxide, a metalloid oxide, a lanthanide oxide, an actinide oxide, preferably, a metal oxide and/or a silicon oxide, more preferentially comprising one or more oxides selected from the group of lithium, sodium, cerium, titanium, vanadium, chromium, molybdenum, manganese, iron, cobalt, palladium, copper, zinc, cadmium, aluminum, silicon, tin and lead oxides and combinations thereof, such as the mixed oxides of cobalt and lithium, of iron and manganese, of lithium and titanium, and the like.

In a particular embodiment according to the invention, said substrate is selected from the group consisting of a metal, of glass or of quartz, of a ceramic support, of any other material coated with titanium dioxide and silicon oxides.

Preferably, wherein said metal is selected from the group consisting of steel, in particular low, medium or high carbon steel, either rolled or not, either coated or not, either shaped or not, flat or shaped stainless steel, platinum, optionally deposited on another support, aluminum, either rolled or not, optionally shaped, more particularly said metal is selected from the group of sheet-coated steel, pre-painted steel, sheet aluminum or steel coated with a titanium dioxide layer.

Alternatively, wherein said glass or quartz is selected from the group consisting of alkaline metal glass or not, either flat or shaped such as in the form of a tube, threads or fibers, quartz in the form of a sheet, of a tube, of threads or further of fibers and the like.

Other embodiments of the composite material according to the invention are indicated in the appended claims.

Other features, details and advantages of the invention will emerge from the description given hereafter, in a non-limiting way and with reference to the appended drawings and to the examples below.

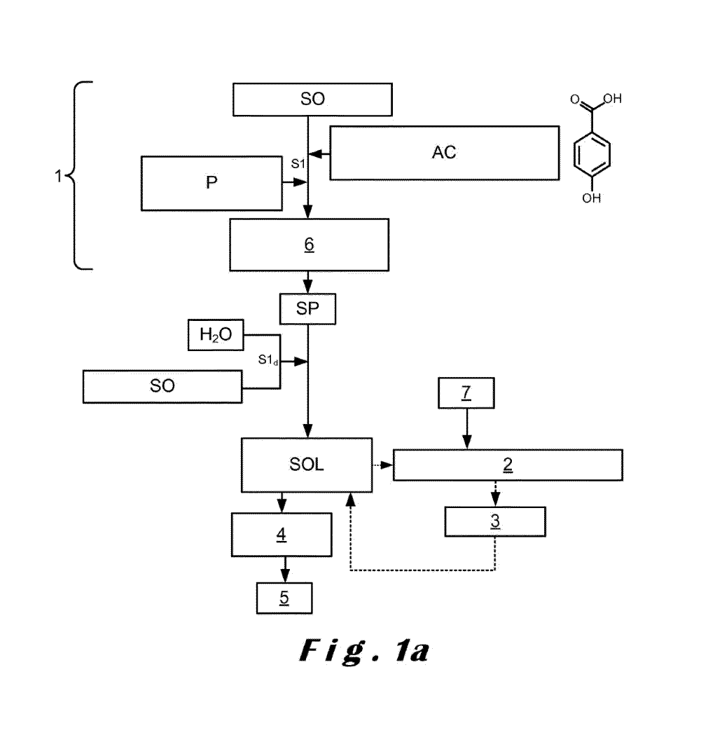

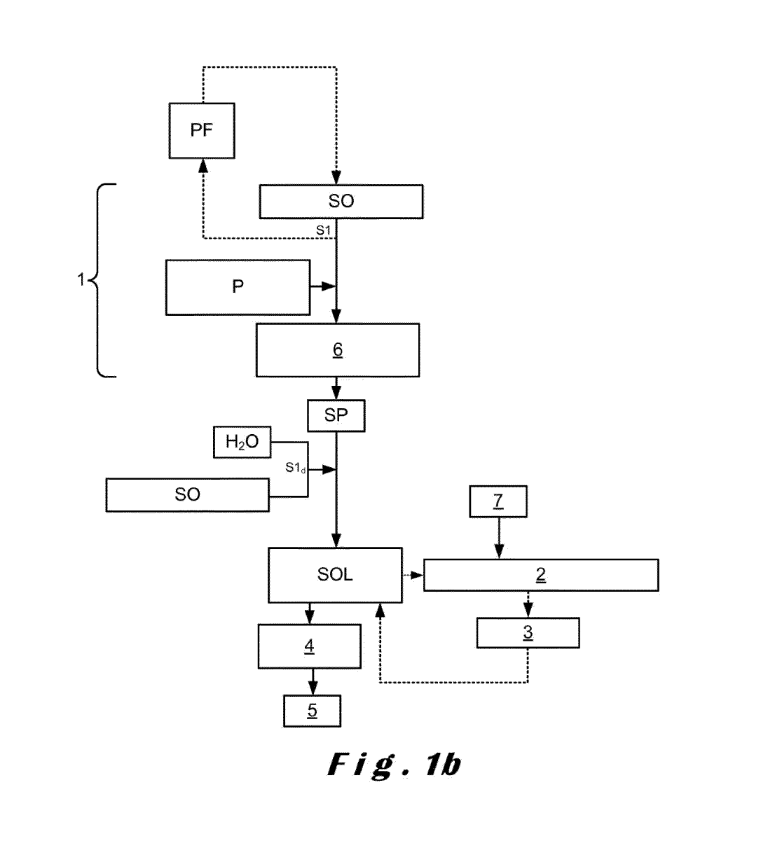

FIG. 1a is a block diagram illustrating an embodiment of the method according to the present invention.

FIG. 1b is a block diagram illustrating an advantageous embodiment of the method according to the present invention.

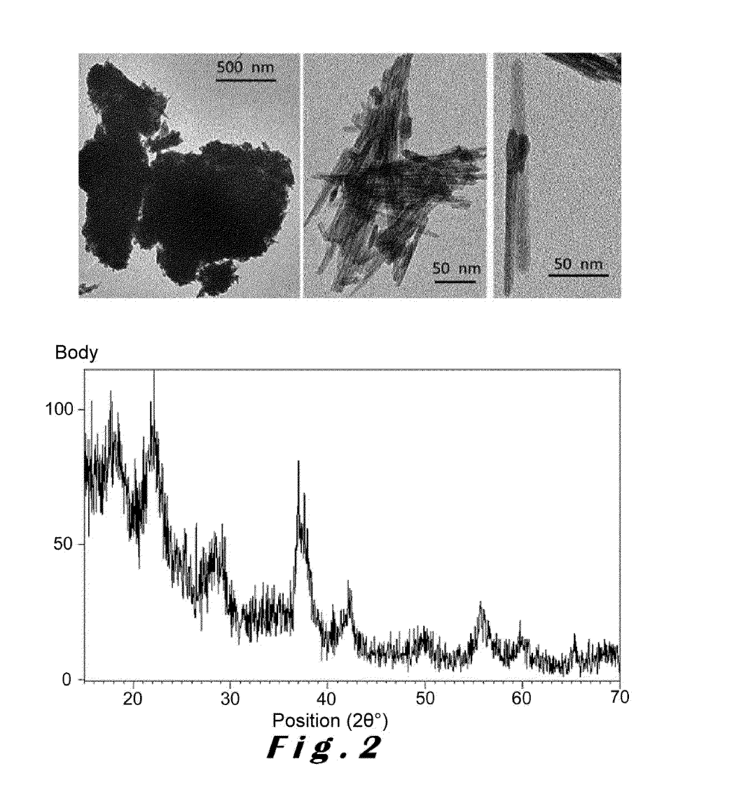

FIG. 2 illustrates the characterization of the powder obtained in Example 1 by TEM (Transmission Electron Microscopy) and by XRD (X-ray Diffraction).

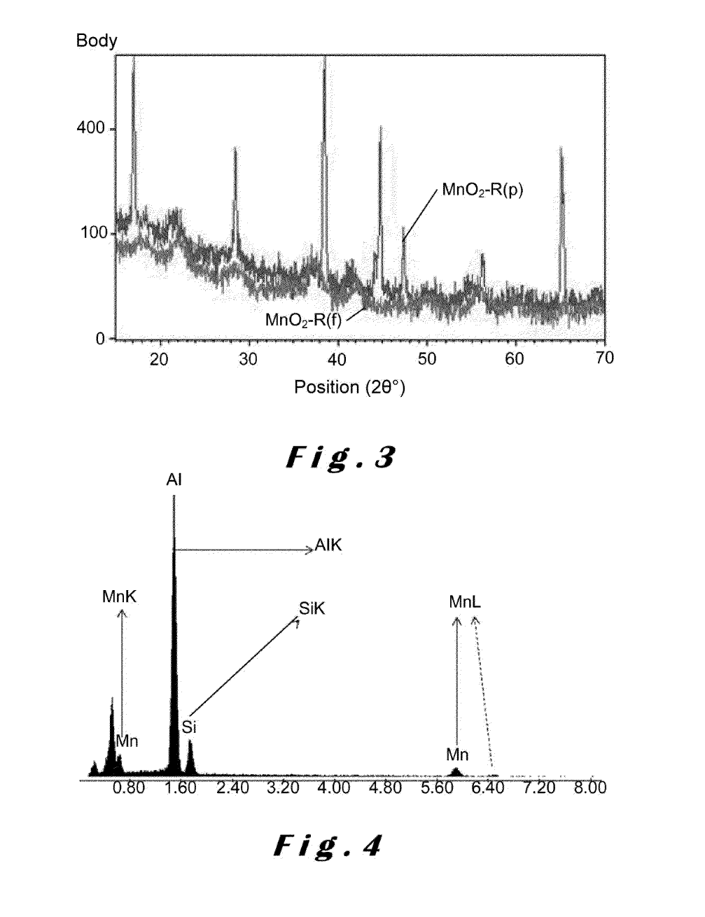

FIG. 3 illustrates the characterization by XRD of the coating obtained on the substrate in Example 1 as compared with the powder characterized in FIG. 2.

FIG. 4 illustrates the elementary characterization by EDX (Energy Dispersive X-Ray spectroscopy) of the coating obtained on the substrate from the powder characterized in FIG. 2.

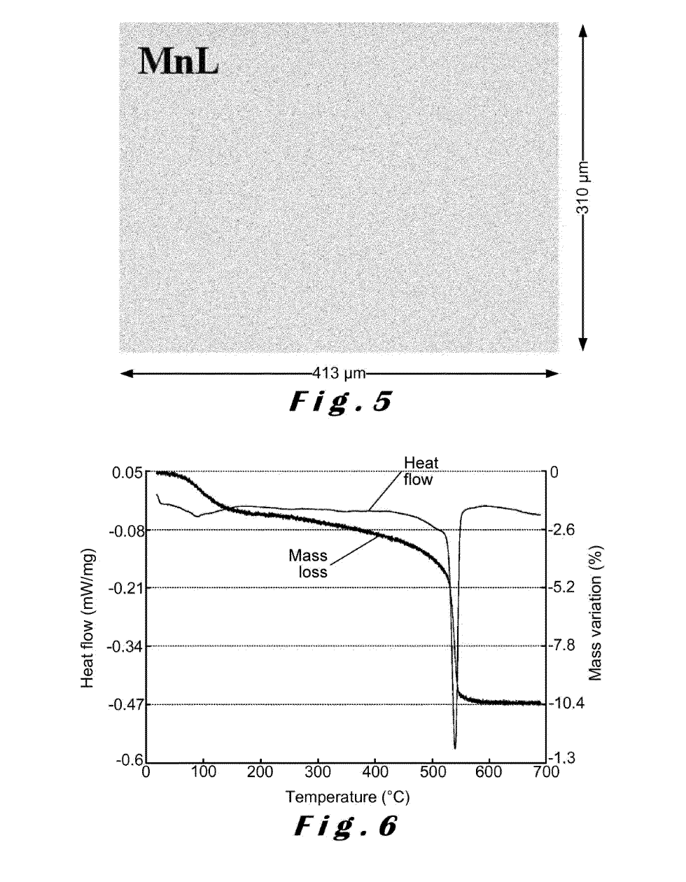

FIG. 5 illustrates the EDX mapping of the coating of FIG. 3 obtained on the substrate from the powder characterized in FIG. 2.

FIG. 6 illustrates the results of the analysis by TG-DSC (Thermogravimetry-Differential Scanning calorimetry) of the coating of FIG. 3 obtained on the substrate from the powder characterized in FIG. 2 as well as an analysis of the powder characterized in FIG. 2.

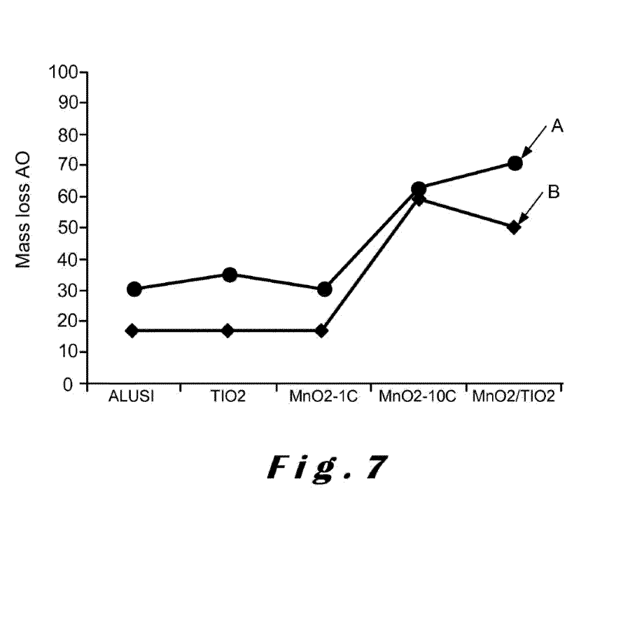

FIG. 7 compares the low temperature degradation rate of an organic molecule (fatty acid) representative of food constituents in the presence of an exposed substrate or covered with a coating of FIG. 3 obtained on the substrate from the powder characterized in FIG. 2.

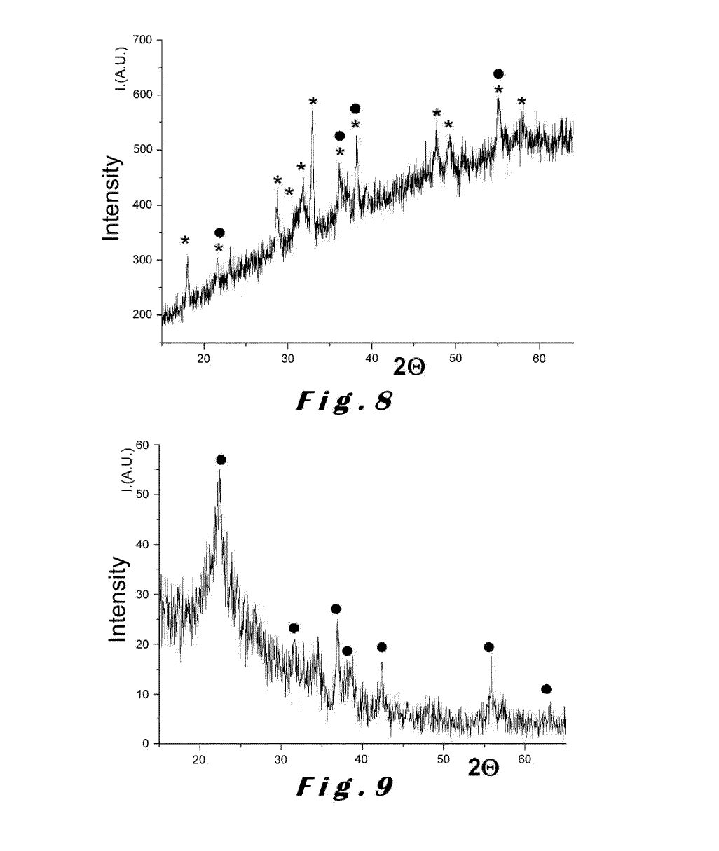

FIG. 8 illustrates the XRD characterization of the reaction product (MnO₂ powder) of the comparative Example 2.

FIG. 9 illustrates the diffraction profiles (XRD) of the R—MnO₂ (MnO₂ ramsdellite) film after drying the comparative Example 3.

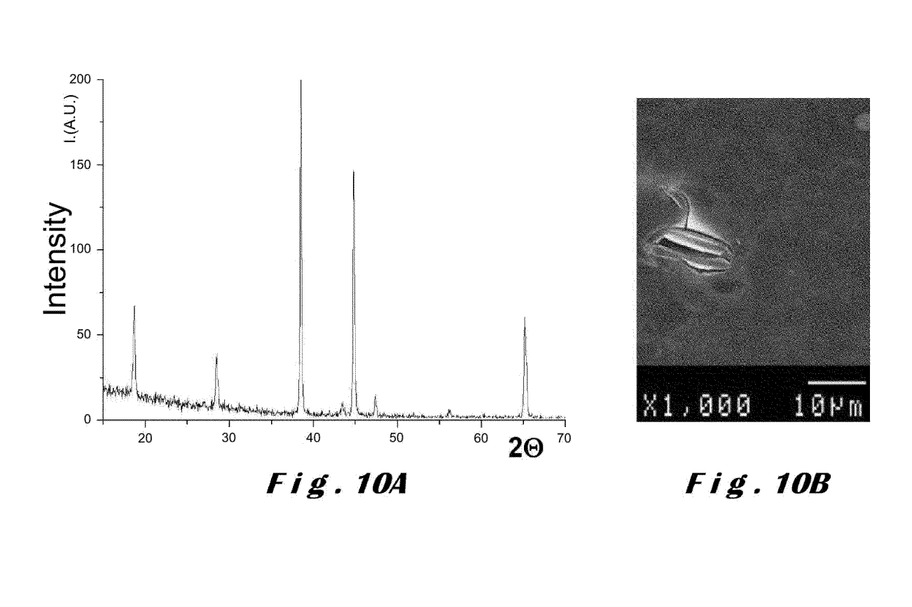

FIGS. 10a and 10b show the diffraction profile (XRD) and the SEM photograph, of the coating of three layers obtained by dip-coating in comparative Example 6, respectively.

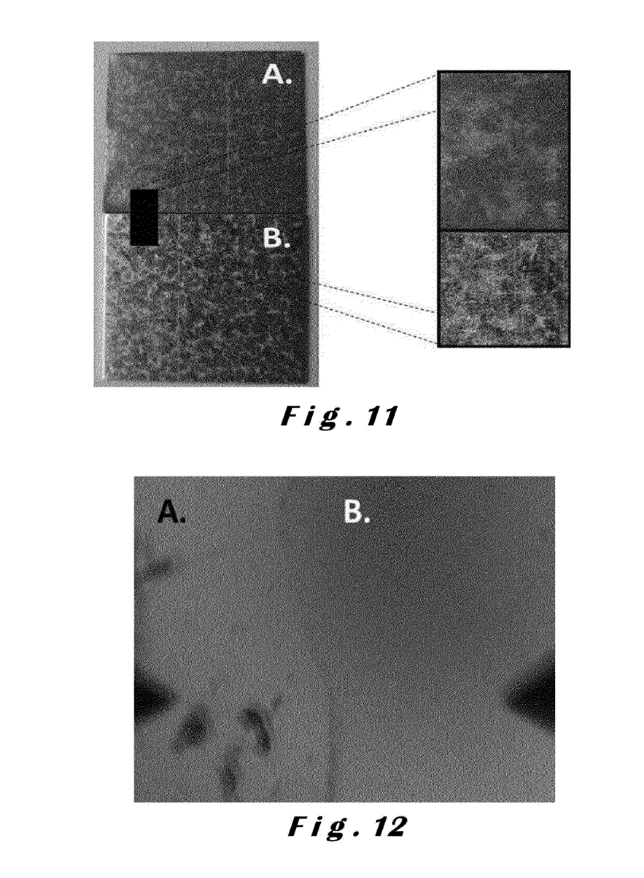

FIGS. 11a and 11b compare the photograph of plates of ALUSI® before (FIG. 11b) and after (FIG. 11a) spin-coating of an LiCoO₂ sol and calcination at 500° C. for 1 h00 of Example 4.

FIGS. 12a and 12b compare the photograph of one of the Pt^{o}/Si plates after spin-coating of an LiCoO₂ sol and calcination at 500° C. for 1 h00 according to Example 5.

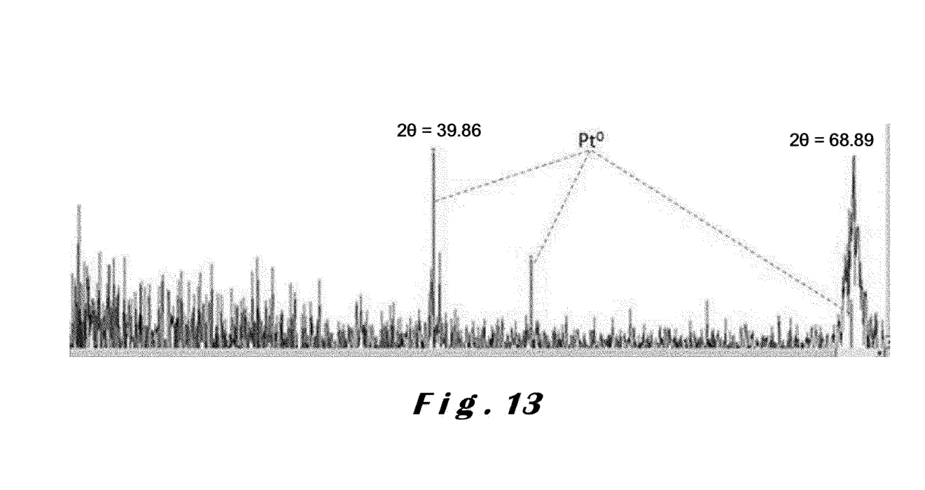

FIG. 13 shows the diffraction profiles of X-rays at XRD grazing angles of the platinum plates before applying the LiCoO₂—C colloid, according to Example 5.

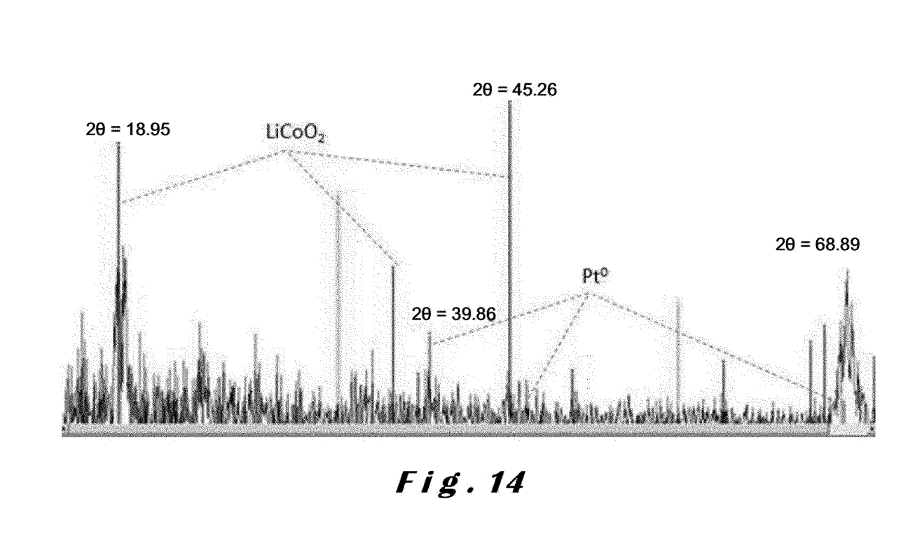

FIG. 14 shows the diffraction profiles of X-rays of platinum plates after applying spin-coating of the LiCoO₂—C system and calcination according to Example 5.

In the figures, identical or similar elements bear the same references.

As this may be seen in FIG. 1a, the present invention therefore relates to method for manufacturing a composite material comprising a substrate and a coating based on powder. The first step of this method lies in functionalization of the substrate (step 7). The substrate is first degreased with a commercial, industrial degreasing agent such as for example the degreasing agent Chemetall Gardoclean S5183. The substrate is then washed with water before being treated with an alcohol solvent and optionally with water, optionally mixed with a carboxylic acid. The alcohol solvent SOA used is an alcohol selected from organic alcohols either saturated or not with a linear chain and provided with at least one alcohol function, more particularly those including an ethanol group and more particularly ethanol.

The substrate is then dried with dry air, preferably at a temperature comprising between 60 and 150° C. The surface treatment of the substrate corresponds to first functionalization of the surface which will allow the selected molecules to be grafted thereon and will therefore allow a reactive surface to be obtained which may then react with the formed colloidal sol.

As this may be seen in FIG. 1a, the method according to the present invention also comprises functionalization (1) of a powder by adding at least one agent bearing a carboxyl or carboxylate function and a second alcohol solvent and optionally water to said powder in order to obtain a suspension (SP).

Preferably, the first colloidal sol SOL1 is prepared in the following way. A first powder P1 is selected depending on the sought properties for coating said substrate. As mentioned, this powder P1 is an oxide powder, a powder of a mixture of oxides or mixed oxides of an identical nature or not.

A solution S1 containing an alcohol solvent mixture (called previously a second alcohol solvent) SO1 and of a mono- or multi-functional carboxylic acid AC1 or of a carboxylate is prepared. The concentration of carboxylic acid in the alcohol solvent is from 0.001 to 2 g/L.

The powder P1 is then dispersed into the solution S1 in a concentration amount comprised in the range from 1 to 10 g/L, or even more from the moment that beyond 10 g/L the solution is saturated, and the obtained dispersion is homogenized (6) with ultrasound for a time period from 15 min to 60 min and with stirring at a rate comprised between 100 revolutions per minute and 5,000 revolutions per minute. The thereby homogenized dispersion is called a suspension Sp1. The molar ratio AC1/P1 is comprised in the suspension Sp1 between 0.001 and 1.

Addition of water to the solution S1 is achieved in order to attain a concentration in water from 1 to 50 g/L. The thereby diluted solution S1 (S1d) is mixed with a suspension Sp1 at a temperature comprised between 10° C. and the reflux temperature of the solvent SO1 and homogenized with ultrasound for a time period from 15 min to 96 hours and under stirring at a rate comprised between 100 revolutions per minute and 5,000 revolutions per minute in order to form the colloidal sol SOL1. The colloidal sol SOL1 is then left to decant for a time period comprised between 1 and 16 h.

The second alcohol solvent SO1 is an alcohol selected from the group of either saturated or not organic alcohols with a linear chain and provided with at least one alcohol function, of ethylene glycol and is preferably, without however being limited thereto, methoxyethanol.

The agent bearing a carboxyl or carboxylate function is a carboxylic acid AC1 selected from the group of mono- or poly-functional carboxylic acids, either having alcohol functions or not, either having benzene rings or not, and either having saturated carbon chains or not and preferably is, without being however limited thereto, para-hydroxybenzoic acid.

FIG. 1b comprises all the steps of the method which have been described for FIG. 1a except that this advantageous embodiment further comprises a prefunctionalization (PF) of the powder. The prefunctionalization is achieved in a prefunctionalization solvent before producing the colloidal sol (Spf). The prefunctionalization step (PF) is advantageously repeated once or several times so as to obtain a sufficiently functionalized powder. The functionalization solution used subsequently (1) is preferentially of an identical or different nature from the one used during the first functionalization and may optionally contain water. Advantageously, when the prefunctionalization step comprises the addition of an agent bearing a carboxyl or carboxylate function to the powder, the subsequent functionalization step does not require the use of at least one agent bearing a carboxyl or carboxylate function, in particular a carboxylic acid, for functionalizing the powder.

The prefunctionalization (PF) consist of prefunctionalizing the powder with a first solvent and then optionally with a second solvent. Next, filtration is carried out and the thereby obtained solid is dried and forms the powder P1 which, in this case is prefunctionalized.

As this may be seen in FIGS. 1a and 1b, which identically describe the subsequent steps for depositing a coating on the substrate, a first powder P1 is selected and dispersed in a functionalization solution Sf containing a functionalization solvent and optionally water. The powder P1 dispersed in the solution Sf is homogenized with ultrasound for a time period from 15 to 60 minutes and under stirring at a rate of 100 to 5,000 revolutions per minute for 24 hours (Sf P1 suspension). Next, the powder was recovered by filtration and rinsed with water before being dried. This solid is the functionalized powder P1.

The functionalized powder P1 is then dispersed into said second solvent in an amount of concentration ranging from 1 to 10 g/L. The obtained dispersion is homogenized with ultrasound for a time period from 15 to 96 hours and under stirring at a rate comprised between 100 and 5,000 rpm.

The thereby homogenized dispersion is called Sp1.

Addition of water to said second solvent SO1 was then carried out for forming a dilute solution S1d.

S1d is thus mixed with Sp1 at a temperature comprised between 10° C. and the reflux temperature of the solvent SO1 and homogenized with ultrasound for a time period from 15 min to 240 min and under stirring at a rate comprised between 100 revolutions per minute and 5,000 revolutions per minute in order to form an intermediate colloidal sol which is then left to decant for a time period comprised between 1 and 16 h.

Finally, a solution containing an agent bearing a carboxyl or carboxylate function, in particular a carboxylic acid AC1, in an alcohol solvent is added to the intermediate colloidal sol in order to form said SOL1.

The thereby formed colloidal sol is then applied by means of conventional coating techniques (2) such as dip-coating, by means of an optionally spiral bar, by vaporization, by centrifugation and the like. The colloidal sol layer applied is then dried by heating at a low temperature (3), i.e., for example by passing into the oven in order to evaporate a portion of the solvent, optionally in the presence of water for a time period from 5 seconds to 5 hours, but, more particularly for a time period from 5 seconds to 0.5 hours with a preference for the time period spreading out from 5 s to 5 min at a temperature comprised between 50 and 190° C., more particularly between 60 and 110° C. and preferentially between 75 and 90° C., this at an absolute pressure comprised between 0.05 and 15 bars, more particularly between 0.5 and 2.5 bars and preferentially between 0.7 and 1.3 bars, before optionally applying another one if necessary. When several layers are necessary, a second and then a third colloidal sol layer and so forth is applied and dried every time before applying the following one.

After a predetermined number of applied layers, (successive applications of the same product or successive applications of different products), a first coating layer formed by said colloidal sol, adherent to the substrate, is formed (5) by heating (4) to a temperature above 50° C. and less than or equal to 500° C., more particularly comprised between 150 and 500° C. with a preference for the range of temperatures from 285 to 415° C., preferably between 300 and 350° C. The time period of the heat treatment is generally comprised between 5 s and 5 h, more particularly between 5 s and 0.5 h, and preferentially between 5 s and 5 min. If necessary, above the first coating layer, other colloidal sol layers are applied, as described earlier. The other applied colloidal sol layers may consist of the same powder, or of another powder.

The reaction times involved during the coating phase and the drying times involved gives the possibility of contemplating without reserve an industrialization of this method.

### EXAMPLES

### Example 1

### Deposition of a Thin Layer of Manganese Dioxide with a Ramsdellite Structure (MnO₂—R) on a Rolled Steel Substrate, Covered with an Aluminum and Silicon Coating (ALUSI)

The goal of the deposition of this thin layer of ramsdellite is to produce an active catalytic surface under the conjugate effect of light and of heat.

Nanoparticles of manganese oxide (MnO₂—R) were synthesized from KMnO₄ and MnSO₄.H₂O by following the procedure proposed by Portehault et al, Chem. Mater. 19 (2007) p 5410-5417.

The immobilization of MnO₂—R was carried out on steel blades of the ALUSI® type of various dimensions in cm: 2×8, 10×10 and 21×29.7 cm².

Before their use, all the ALUSI® blades were degreased with Gardoclean S5183 from Chemetal, washed (H₂O, ethanol) and dried at 120° C. (1 h).

A solution S1 of carboxylic acid was prepared by mixing 0.5 g of 4-hydroxybenzoic acid in 500 mL of 2-methoxyethanol. From S1, a second mixture was prepared by adding 0.75 mL of deionized water in 30 mL of S1, this aqueous mixture forms a dilute solution S1.

Next, 0.3 g of manganese dioxide (MnO₂—R) were suspended and dispersed in 30 mL of the solution S1 with ultrasound (30 min) and with stirring (1500 rpm, for 2 h) (suspension Sp1). To this suspension, 30 mL of the dilute solution S1 were added, the solution was then homogenized with ultrasound for 30 min and stirred for 2 h.

During this time, the formation of a colloidal phase (black) is observed, the excess solid was left to decant for 16 h, this colloidal solution is designated as SOL1.

Immobilization of MnO₂—R on ALUSI®

The functionalized steel blades, obtained above are placed in the automatic film applicator. A specific volume of the solution SOL1 is deposited on the blades. The deposited volume changes depending on the dimensions of the plate: it is 0.125 mL, 0.580 mL, 1,200 mL for blades (in cm): 2×8, 10×10 and 21×29.7 cm², respectively.

A first layer of the colloidal solution SOL1 is applied on the blades. The blades are then dried at 80° C. under an air flow for 1 h. Next, this application and drying procedure at 80° C. is repeated until 10 layers are formed. Finally, the blades are heat treated at 500° C. (with a heating ramp of 20° C./min) under air flow (for 1 h).

The characterization of the powder with XRD (see FIG. 2) gives the possibility of making sure that the initial powder is actually ramsdellite. Another characterization with TEM allows definition of the nanometric size of the isolated particles of the powder (of the order of 10 to 30 nm wide over a length of 50 to 120 nm) (FIG. 2).

The characterization with XRD of the coating on the substrate gives the possibility of making sure that the peaks present (see FIG. 3) on the diffractogram correspond to the powder (illustrated in FIG. 1) and to the substrate, which proves the capability of the method which is the subject of the invention of depositing without any contamination a pure powder on a substrate (FIG. 3).

The characterization with EDX of the substrate and of the layer gives the possibility of again validating the purity of the deposit and the absence of any contamination from compounds of the synthesis (FIG. 4).

The characterization by EDX mapping further allows validation of the homogeneity of the deposit at a micrometric scale (FIG. 5).

The characterization by TG-DSC of the deposit prepared according to the method according to the invention allows validation that the signals of the coating and of the initial powder are actually the same and that they are not altered by the products used for contributing to the deposit of a thin layer. Thus, this again validates that the deposit is pure.

Moreover, as the target here is to form an active catalytic layer under the combined effect of light and of heat, it may be seen in FIG. 7 that the positive effect of the MnO₂—R layer is to allow doping by a factor greater than 4 the degradation rate of an organic pollutant characteristic of food waste.

The adherence of the thereby formed layer is evaluated with different tests, such as the test of the adhesive, the resistance to soaking in water and acetone, the washing with ethanol, the dry friction test, the folding of the substrate, the calorific test for measuring the loss of material at 250° C. and at 500° C. and the resistance to UV/visible radiations in water.

The test of the adhesive consists of using an adhesive of the Scotch® brand available from 3M, which is affixed onto the coating and which is removed. The amount of detached material is then evaluated on the transparent portion of the adhesive by visual inspection.

The resistance to soaking in water and in acetone consists of immersing for a duration of 24 hours the substrate coated with the powder in water or in acetone. The product immersed in water or in acetone is then visually compared to a non-soaped product.

The test of the washing with ethanol consists of immersing into an ethanol solution, with stirring between 50 and 100 rpm, without rubbing the substrate coated with the oxide layer for a duration of 24 hours. Visual evaluation is then practiced in order to detect whether portions of the coating have been detached from the substrate.

The dry friction test consists of performing 100 round trips with a dry cloth of the TORK brand. A visual inspection of the cloth and of the coated substrate allows evaluation of the measurement of the adherence of the coating.

The calorific test for measuring the material loss at 250° C. and at 500° C. consists of raising the substrate covered with the oxide layer to a temperature of 250 and 500° C. The material loss is then evaluated qualitatively.

The test of the resistance to UV/visible radiations in water consists of placing the substrate covered with the oxide layer under UV/visible radiation in water for 24 h. Visual inspection of the degradation of the surface is then practiced.

The thereby coated substrate with the oxide layer showed that the adherence was satisfactory insofar that the sample satisfied the whole of the test above. Finally, the samples obtained according to Example 1 were subject to a peelability test of the coating according to the ASTM 4541 standard.

Steel test bodies (surface of 3.1 cm²) are adhesively bonded by means of an epoxy adhesive without any solvent with two components of the slow drying type to two steel plates coated according to Example 1.

The traction force is applied perpendicularly to the surface.

After failure, the type of the latter is evaluated and the magnitude of the force is noted in table 1 shown below.

TABLE 1

| Measurement | Plate A (N/mm²) | Plate B (N/mm²) |
|---|---|---|
| 1 | 18.71 | 17.66 |
| 2 | 17.45 | 15.74 |
| 3 | 17.72 | 17.35 |
| 4 | 16.29 | 16.76 |
| 5 | 17.45 | 16.50 |
| Average | 17.52 | 16.80 |
| Nature of the failure | Adhesive failure between | Adhesive failure between |
| | the adhesive and the | the adhesive and the |
| | coating | coating |

As may be seen, the adherence of the coating is higher than that obtained with the 2-component epoxy adhesive.

### Example 2

Deposition of a manganese dioxide layer (ramsdellite) on an aluminum substrate.

A powder of manganese dioxide is synthesized according to the procedure described in Example 1.

This powder is then put into a colloidal solution by mixing it according to the procedure resumed in Example 1 and the substrate is also treated in the same way as described in Example 1.

The test for checking the nature of the coating led to the conclusions that the powder was pure and dispersed homogenously at the surface of said substrate. Further, the different adherence tests conducted showed that the adherence of the annealed coating was satisfactory.

### Example 3

Deposition of a manganese dioxide layer (ramsdellite) on a steel substrate coated with titanium dioxide.

A titanium dioxide film is deposited by dip coating on the basis of a sol synthesized by modification of a method described in Microporous and Mesoporous Materials 122 (2009) 247-254.

The steel was therefore coated beforehand with titanium dioxide and was then used as a substrate for Example 3. The reproduced procedure is the one of Example 1.

The tests for checking the nature of the coating led to the conclusions that the powder was pure and dispersed homogenously at the surface of said substrate. Further, the different conducted adherence tests showed that the adherence of the annealed coating was satisfactory.

### Example 4

Deposition of a thin layer of commercial cobalt (III) and lithium oxide (LiCoO₂—C) on a laminated steel substrate, covered with an aluminum and silicon coating (ALUSI).

The cobalt and lithium oxide (LiCoO₂—C) was purchased from Aldrich Chemistry (batch#MKBF6341V). Immobilization of LiCoO₂—C was carried out on steel blades of the ALUSI® with dimensions: 2×2 cm².

Before their use, all the ALUSI® blades were degreased, washed (H₂O, ethanol) and dried at 120° C. (1 h).

LiCoO₂—C Pre-Functionalization Step:

An aqueous functionalization solution Sf of carboxylic acid was prepared by mixing 1.0 g of 4-hydroxybenzoic acid in 200 mL of deionized H₂O. Next, 4.0 g of LiCoO₂—C were suspended and dispersed in 150 mL of the solution Sf with ultrasound (30 min) and with stirring (1500 rpm, for 24 h) (suspension Sfp1). Finally, the suspension Sfp1 was filtered and the solid was washed with de-ionized water (450 mL) and dried for 24 hours at 80° C. This functionalized and dried solid will be designated below as LiCoO₂—C/F.

Step for Forming a Colloidal Sol

Next, 0.5 g of LiCoO₂—C/F were suspended and dispersed in 50 mL of ethanol (Sp1). The dispersion was carried out with ultrasound (30 min) and with stirring (1,500 rpm for 2 h) (suspension Sp1). To Sp1 was added a mixture (Sd1) of 50 mL of ethanol (S1) and 1.25 mL of de-ionized water), the solution was then sonicated with ultrasound for 3 h and stirred for 1 h. In order to separate the excess solid from the colloidal solution, the suspension was left to decant for 16 h and centrifuged at 5,000 rpm for 15 mins (15° C.).

Finally, to 20 mL of the resulting colloidal solution were added 2 mL of a 4-hydroxybenzoic acid solution in 2-methoxy-ethanol (10 g/L), this colloidal solution is designated as SOL1.

Immobilization of LiCoO₂—C on ALUSI

The steel blades prepared, obtained above are placed on the spin-coater. A first layer of the colloidal solution is applied on the blades by depositing between 15 and 20 μl of the SOL1 solution. Next, spin coating is actuated at 2,000 rpm for 20 s, is then interrupted for a period of 45 s, the time required for drying the solvent. Next, this application and drying procedure is repeated until 1 to 2 mL of SOL1 are added.

Finally, the blades are heat-treated at 500° C. (20° C./min) under an airflow (for 1 h).

FIG. 11 compares the photograph of 1 of the ALUSI® plates before (FIG. 11b) and after (FIG. 11a) spin-coating and calcination at 500° C. for one hour. The presence of a deposit (tanned film) of a solid homogenously distributed over the steel plate coated with an ALUSI® layer (grey background).

### Example 5

Deposition of a thin layer of commercial cobalt (III) and lithium oxide (LiCoO₂—C) on a silicon substrate covered with a platinum coating (Pt^{o}/Si).

The cobalt and lithium oxide was obtained from Aldrich Chemistry (batch#MKBF6341V). The immobilization of LiCoO₂—C was carried out on Pt^{o}/Si blades with dimensions of 2×2 cm².

This powder is functionalized according to the procedure resumed in Example 4 (functionalization step, LiCoO₂—C/F), it is then put into a colloidal solution and deposited according to the procedure resumed in Example 4 (immobilization of LiCoO₂—C) and the substrate is also pre-treated in the same way as described in Examples 1 and 4.

FIG. 12 compares the photograph of one of the plates of Pt^{o}/Si after spin-coating and calcination at 500° C. for 1 h. Two areas may be observed (A and B). The area A corresponds to the portion of the platinum plate where the colloid is not applied and the area B shows the presence of a homogenously dispersed solid.

FIG. 13 shows the diffraction profiles of X-rays at grazing angles (XRD) of the platinum plates before applying the LiCoO₂—C colloid and it also shows the typical peaks observed for platinum metal. It is observed that on the virgin platinum metal blades, two main peaks are observed at 2θ=39.86 and 68.69. These peaks coincide with the characteristic peaks of platinum metal (identified as Pt⁰).

FIG. 14 shows the diffraction profiles of XRD of platinum plates after the spin-coating application of the LiCoO₂—C system in ethanol and after calcination at 500° C. for 1 h. FIG. 14 shows that in addition to the characteristic peaks of platinum (2θ=39.86 and 68.89), two other new peaks are observed at 2θ=18.95 and 45.26. These new peaks coincide with the most intense signals of the characteristic crystallographic profile of LiCoO₂—C (lines identified as LiCoO₂—C).

### Example 6

Deposition of a thin layer of commercial cobalt (III) and lithium oxide (LiCoO₂) on an SiO₂ substrate covered with a pure platinum coating (Pt^{o}), a coating which is particularly difficult to coat.

The cobalt and lithium oxide (LiCoO₂) was purchased from Sigma-Aldrich (CAS no.: 12190-79-3). The immobilization of LiCoO₂ was carried out on SiO₂ discs covered with a platinum coating (Pt^{o}, diameter=15 cm).

Before their use, the discs were degreased, washed and dried. Attachment of the LiCoO₂ was carried out by spray coating.

### LiCoO₂ Pre-Functionalization Step

An aqueous functionalization solution Sf of carboxylic acid (SA1) was prepared by mixing 3.0 g of 4-hydroxybenzoic acid (4-HB) in 600 mL of de-ionized water, with stirring (1,500 rpm) and by maintaining the temperature at 60° C. (1 h). Next, 36 g of LiCoO₂ were suspended in the solution SA1 with stirring (1,500 rpm, for 24 h) and by maintaining the temperature at 60° C. (suspension SA2). Next, the black solid (LiCoO₂—HB) was recovered by filtration of SA2 and was washed with de-ionized hot water (1.2 L, 60° C.). The solid LiCoO₂—HB was dried at 80° C. for 24 h.

### Step for Forming a Colloidal Sol

For preparing the LiCoO₂—HB colloid, two solutions were used: a solution S1 of 300 mL of pure 2-methoxyethanol and a solution S2 was prepared by adding 7.2 mL of de-ionized water in 300 mL of 2-methoxyethanol.

Next, 3.0 g of LiCoO₂—HB were suspended and dispersed in 50 mL of the solution S1 (2-methoxyethanol) with ultrasound (30 min) and with stirring (1,500 rpm, for 30 min) (suspension Sp1). To this suspension, 50 mL of the solution S2 were added. The solution was then sonicated with ultrasound for 24 h. During this period, the formation of a colloidal phase is observed. The excess solid was separated by a first centrifugation carried out at 5,000 rpm for 1.5 minutes (18° C.) and by a second centrifugation carried out at 8 rpm for 8.5 minutes (18° C.). Finally, 100 mL of the LiCoO₂—HB/methoxyethanol/H₂O colloid were obtained.

The whole procedure for forming the LiCoO₂—HB colloidal sol was repeated six times until about 600 mL of the LiCoO₂—HB/methoxyethanol/H₂O colloid was obtained.

### Pre-Treatment of the SiO₂/Pt^{o} Discs

A degreasing solution was prepared by mixing 15 g of the S5183 product (Gardoclean from Chemetal) in 1 L of de-ionized water. Each of the discs was slowly immersed in this degreasing solution for 2 s and finally slowly extracted from the solution. Both of these steps were repeated 10 times. Next, the blades were washed with de-ionized water. The discs were dried at 120° C. for 1 h.

### Immobilization of LiCoO₂—HB/Methoxy-Ethanol-H₂O

The disc is placed on the support at the centre of the spray coating device which was pre-heated to 120° C. Next, spray coating of the LiCoO₂—HB/methoxy-ethanol/H₂O colloid was carried out and allowed deposition of 550 mL of the LiCoO₂—HB/methoxy-ethanol/H₂O at 120° C. After drying, an amount of 0.10492 g of LiCoO₂—HB was deposited on the SiO₂/Pt^{o} substrate. Finally, the calcination step carried at 350° C. for 1 h (20° C./min) allowed deposition of LiCoO₂ in an amount of 0.04836 g.

### COMPARATIVE EXAMPLE 1

### Immobilization In Situ of MnO₂ During Sol-Gel Synthesis of MnO₂-Bimessite

By a variation of the method proposed by Segal et al (Chem. Mater. 1997, 9, 98-104), the immersion of ALUSI® was carried out in a gel formed from the interaction between KMnO₄ and saccharose. The thereby immersed blades in the gel were then dried in an oven at 110° C. for 24 hours.

The substrates were then heated to 450° C. for 24 h. After heating, a black film was observed. However, this film was not very homogenous and did not have much mechanical and chemical stability. Further, it detached upon contact with water.

### COMPARATIVE EXAMPLE 2

### Immobilization In Situ of MnO₂ During Sol-Gel Synthesis of MnO₂-Nsutite

This method was at the origin proposed for obtaining nsutite manganese oxide in powder (J. Sol-Gel Sci. Technol. 2009, 51, 169-174). In this example, the same procedure was followed but the blades were introduced during gelling of MnAc₂ (Manganese acetate 2) in the presence of citric acid, in order to obtain MnO₂ films. The application of the gel was carried out with three techniques, immersion, dip-coating and spin-coating. However, the lack of affinity between the solvent and the blades did not allow formation of a layer on the substrate. Finally, the characterization with XRD illustrated in FIG. 8 of the reaction product (MnO₂ powder) showed that this is not specifically MnO₂-nsutite unlike what was suggested by the article.

### COMPARATIVE EXAMPLE 3

### Immobilization of the MnO₂-Ramsdellite Powder Via Co-Gelling in the Silicate Film

A set load of R—MnO₂ was added at different concentrations to a sodium silicate aqueous solution (28.5, 14.2, 7, 3.5 and 2.8% by weight). The suspensions were subject to ultrasound for 30 minutes and were stirred for a further 30 minutes. The mixtures were deposited on ALUSI® blades by spin-coating, dip-coating and spatula-coating. The films were finally dried at 120° C. for 24 hours. From all the obtained films, the film prepared via spatula-coating and with a concentration of 2.8% of SiO₂ was the only one which exhibited acceptable mechanical stability. FIG. 9 shows the diffraction profiles (XRD) of R—MnO₂ of the film after drying. As may be seen, the MnO₂ of the ramsdellite type is maintained after the immobilization process (black circles). However, its stability upon contact with water is very low.

### COMPARATIVE EXAMPLE 4

### Immobilization of the MnO₂-Ramsdellite Powder Via Co-Gelling in the Polyvinylidene Fluoride Film

0.005 g of R—MnO₂ was added to a PVDF solution in N-methylpyrollidone (NMP). The suspension was subject to ultrasound for a period of 10 min and then stirred for a further 5 min. The mixture was then deposited on blades via impregnation and was dried at 120° C. for 24 h. The film exhibited low mechanical and chemical stability.

### COMPARATIVE EXAMPLE 5

### Immobilization of the MnO₂-Ramsdellite Powder Via Co-Gelling in the Silicate Film

By following the procedure according to scheme 2, J. Catal. 1997, 170, 366-376, after having suspended R—MnO₂ in alcohol, the mixture was split into two for adding TEOS (tetraethyl orthosilicate) and water respectively. The sol did not exhibit any stability and immediately formed a gel without forming a film on the ALUSI® blade.

### COMPARATIVE EXAMPLE 6

### Immobilization of the MnO₂-Ramsdellite Powder Via Co-Gelling with TiO₂

Comparative Example 5 was reproduced except that the R—MnO₂ was suspended in 2-methoxyethanol until a stable solution was formed. The colloid was then split into two portions. Titanium tetraisopropoxide was added to the first portion while water was added to the second portion. The R—MnO₂/TiO₂ films were prepared during gelling: (i) by spin-coating or dip-coating or spray-coating and were then dried at 80° C. for 1 h. Three layers were thus applied. FIGS. 10a and 10b show the diffraction profile (XRD) and the SEM photograph, respectively, of the coating of three layers obtained by dip-coating. Although these films exhibit great stability chemically and mechanically, the presence of R—MnO₂ was not observed.

It is well understood that the present invention is by no means limited to the embodiments described above and that many modifications may be brought thereto without departing from the scope of the appended claims.

1. A method for manufacturing a composite material comprising a substrate and a coating based on powder, comprising
a) functionalization of the substrate comprising a treatment of a surface of said substrate with a first solution containing at least one first alcohol solvent,
b) formation of a first stable colloidal sol,
c) at least one application of at least one layer of said first colloidal sol on the functionalized substrate,
d) drying of said at least one layer of said first colloidal sol and
e) formation of a first coating layer formed with said first colloidal sol, adhering to said substrate, by heating to a temperature above 50° C. and below 500° C., characterized in that the method further comprises:
f) before the formation of said first stable colloidal sol, functionalization of a first powder and in that said first stable colloidal sol is based on said first powder, functionalized in a second solvent, said coating being formed with said first uniformly distributed powder.

2. The method according to claim 1, wherein said steps c) and d) are repeated alternately a predetermined number of times corresponding to the number of layers of said first powder in order to form said first coating.

3. The method according to claim 1, further comprising the steps:
a) functionalization of an nth powder (n≧2) and formation of an nth (n≧2) colloidal sol containing said nth (n≧2) powder, functionalized in a Zth (Z≧n+1) solvent,
b) application of at least one layer of said nth colloidal sol of said nth powder on the substrate coated with said (n−1)th coating,
c) drying of said at least one layer of said nth colloidal sol and,
d) optionally formation of a coating layer formed with said nth colloidal sol of said nth powder, adhering to said (n−1)th coating, by heating to a temperature above 50° C. and below 500° C.

4. The method according to claim 3, wherein said steps b) and c) are alternately repeated a predetermined number of times corresponding to the number of layers of said nth powder in order to form said nth coating.

5. The method according to claim 1, wherein said first and/or said nth colloidal sol contains water.

6. The method according to claim 1, wherein said powder is a powder comprising an alkaline oxide, an earth-alkaline oxide, a transition metal oxide, a low metal oxide, a metalloid oxide, a lanthanide oxide, an actinide oxide, preferably a metal oxide and/or a silicon oxide, more preferentially comprising one or several oxides selected from the group of lithium, sodium, cerium, titanium, vanadium, chromium, molybdenum, manganese, iron, cobalt, palladium, copper, zinc, cadmium, aluminum, silicon, tin and lead oxides and combinations thereof, such as mixed oxides of cobalt and lithium, of iron and manganese, of lithium and titanium, and the like.

7. The method according to claim 1, wherein said substrate is selected from the group consisting of metal, glass or quartz, a ceramic support, or any other material coated with titanium dioxide and silicon oxides.

8. The method according to claim 7, wherein said metal is selected from the group consisting of steel, in particular low, medium or high carbon steel, either rolled or not, coated or not, shaped or not, flat or shaped stainless steel, platinum, optionally deposited on another support, aluminum, rolled or not, optionally shaped, more particularly, said metal is selected from the group of sheet-coated steel, pre-painted steel, sheet aluminum or steel coated with a titanium dioxide layer.

9. The method according to claim 7, wherein said glass or quartz is selected from the group consisting of either alkaline or not glass, flat or shaped glass such as in the form of a tube, threads or fibers, quartz in the form of a sheet, of a tube, of threads or further of fibers and the like.

10. The method according to claim 1, wherein said first and/or said nth colloidal sol is formed in the presence of an agent bearing a carboxyl or carboxylate function.

11. The method according to claim 10, wherein said step for functionalization of said first powder with formation of said first colloidal sol containing said first functionalized powder comprises the steps:
a) preparing a first solution S1 of said agent bearing a carboxyl or carboxylate function in said second solvent (SO1), which is selected from organic alcohols either saturated or unsaturated with a linear chain, comprising at least one alcohol function,
b) preparing a suspension Sp1 by dispersing said first powder into said first solution S1,
c) adding water to said first solution S1 in order to form a dilute solution S1d,
d) mixing said dilute solution S1d and said suspension Sp1 at a temperature comprised between 10° C. and the reflux temperature of said second solvent, and
e) homogenizing said mixture until said first colloidal sol containing said first functionalized powder is obtained.

12. The method according to claim 10, wherein said step for functionalization of said nth (n≧2) powder with formation of an nth (n≧2) colloidal sol containing said nth functionalized powder (n≧2) comprise the following steps:
a) preparing an nth (n≧2) solution Sn of said agent bearing a carboxyl or carboxylate function in said Zth (Z≧n+1) solvent (SO₂),
b) preparing a suspension Spn by dispersing said nth powder (n≧2) into said nth (n≧2) solution Sn,
c) adding water to said nth (n≧2) solution Sn in order to form an nth dilute solution (n≧2), Snd,
d) mixing said nth (n≧2) dilute solution Snd and said suspension Spn at a temperature comprised between 10° C. and the reflux temperature of said Zth (Z≧n+1) alcohol solvent and
e) homogenizing said mixture until said nth (n≧2) colloidal sol is obtained containing said nth functionalized powder (n≧2).

13. The method according to claim 1, wherein said first powder is functionalized in a functionalization solvent Sf, optionally in the presence of water and wherein said first colloidal sol is formed by the steps:
a) preparing a suspension Sp1 by dispersing said first functionalized powder into said second solvent SO₁.
b) adding water to said second solvent SO₁ in order to form a dilute solution S₁d,
c) mixing said dilute solution S1d and said suspension Sp1 at a temperature comprised between 10° C. and the reflux temperature of said second solvent SO1,
d) homogenizing said mixture until an intermediate colloidal sol containing said first functionalized powder is obtained and,
e) adding to said intermediate colloidal sol a solution containing an agent bearing a carboxyl or carboxylate function in a third solvent, preferably an alcoholic solvent in order to form said first colloidal sol SOL1.

14. (canceled)

15. The method according to claim 1, wherein said first alcohol solvent, said second solvent, said third solvent and said Zth (Z≧n+1) solvent are selected independently of each other from the group consisting of water and of organic alcohols, either saturated or unsaturated with a linear chain, comprising at least one alcohol function, and preferably selected from the group of methoxyethanol, ethanol, ethylene glycol, 1-propanol, methanol, n-butanol, 2-phenylethanol and 2-propanol and mixtures thereof and may be either identical or different.

16. The method according to claim 1, wherein said first alcohol solvent comprises an additive, preferably selected from the group of ethylene glycol, polyethylene glycol 200, polyethylene glycol 400, polyethylene glycol 1500, polyethylene glycol 10,000 and polyethylene glycol 1,500,000, ethoxylated natural fatty alcohols, preferably based on stearyl alcohol, more particularly Brij® S10, Pluronic F120®, sodium dodecylbenzene sulfonate and 4-hydroxybenzoic acid as well as mixtures thereof.

17. The method according to claim 1, wherein said functionalization solvent is selected from the group consisting of ethylene glycol, polyethylene glycol 200, polyethylene glycol 400, polyethylene glycol 1500, polyethylene glycol 10,000 and polyethylene glycol 1,500,000, ethoxylated natural fatty alcohols, preferably based on stearyl alcohol, more particularly Brij® S10, Pluronic F120®, and sodium dodecylbenzene sulfonate, para-hydroxybenzoic acid, as well as mixtures thereof.

18. The method according to claim 1, wherein said agent bearing a carboxyl or carboxylate function is selected from the group of monofunctional or polyfunctional carboxylic acids, optionally having alcohol chains and/or optionally benzene rings and/or having saturated or unsaturated carbon chains, preferably, said agent bearing a carboxyl or carboxylate function is 4-hydroxybenzoic acid.

19. A material comprising a substrate and at least one coating based on powder characterising that said coating consists of said powder and exhibits adherence to said substrate greater than 17 N/mm² according to the ASTM4541 standard.

20. The material according to claim 19, further comprising an nth coating (n≧2) based on an nth powder, wherein said nth coating consists of said nth powder.

21. The material according to claim 19, wherein said powder is a powder comprising an alkaline metal oxide, an earth-alkaline metal oxide, a transition metal oxide, a low metal oxide, a metalloid oxide, a lanthanide oxide, an actinide oxide, preferably a metal oxide and/or a silicon oxide, more preferentially comprising one or more oxides selected from the group of lithium, sodium, cerium, titanium, vanadium, chromium, molybdenum, manganese, iron, cobalt, palladium, copper, zinc, cadmium, aluminum, silicon, tin and lead oxides and combinations thereof, such as mixed oxides of cobalt and lithium, of iron and manganese, of lithium and of titanium, and the like.

22. The material according to claim 19, wherein said substrate is selected from the group consisting of a metal, of glass or quartz, of a ceramic support, or of any other material coated with titanium dioxide and silicon oxides.

23. The material according to claim 22, wherein said metal is selected from the group consisting of steel, in particular low, medium or high carbon steel, either rolled or not, coated or not, shaped or not, flat or shaped stainless steel, platinum, optionally deposited on another support, aluminum, either rolled or not, optionally shaped, more particularly, said metal is selected from the group of sheet-coated steel, pre-painted steel, sheet aluminum or steel coated with a titanium dioxide layer.

24. The material according to claim 22, wherein said glass or quartz is selected from the group consisting of an alkaline glass or not, either flat or shaped such as in the form of a tube, threads or fibers, quartz in the form of a sheet, a tube, threads or further fibers and the like.

25. The method according to claim 3, wherein said first powder is functionalized in a functionalization solvent Sf, optionally in the presence of water and wherein said first colloidal sol is formed by the steps:
e) preparing a suspension Sp1 by dispersing said first functionalized powder into said second solvent SO₁;
f) adding water to said second solvent SO₁ in order to form a dilute solution S₁d;
g) mixing said dilute solution S1d and said suspension Sp1 at a temperature comprised between 10° C. and the reflux temperature of said second solvent SO1;
h) homogenizing said mixture until an intermediate colloidal sol containing said first functionalized powder is obtained; and
i) adding to said intermediate colloidal sol a solution containing an agent bearing a carboxyl or carboxylate function in a third solvent, preferably an alcoholic solvent in order to form said first colloidal sol SOL1, and
wherein said nth powder (n≧2) is functionalized in a functionalization solvent Sf, optionally in the presence of water and wherein said nth colloidal sol is formed by the steps:
j) preparing a suspension Spn by dispersing said nth powder (n≧2) in said Zth (Z≧n+1) solvent (SOZ);
k) adding water to said Zth solvent (Z≧n+1) in order to form a dilute solution Snd;
l) mixing said dilute solution Snd and said suspension Spn at a temperature between 10° C. and the reflux temperature of said Zth solvent (Z≧n+1);
m) homogenizing said mixture until an intermediate colloidal sol of a solution containing said nth functionalized powder is obtained; and
n) adding to said intermediate colloidal sol a solution containing an agent bearing a carboxyl or carboxylate function in a third solvent, preferably an alcohol solvent in order to form said nth colloidal sol SOLn.
